(19) United States
(12) Patent Application Publication
(10) Pub. No.: US 2007/0249874 A1
(43) Pub. Date: Oct. 25, 2007

(54) Synthesis of the Micro-Porous Silica Gel and Its Application to the Preparation of Catalysts for C2 Oxygenates Synthesis from Syngas

(75) Inventors: Hongyuan Luo, Dalian (CN); Yunjie Ding, Dalian (CN); Hongmei Yin, Dalian (CN)

Correspondence Address: NIXON & VANDERHYE, PC, 901 NORTH GLEBE ROAD, 11TH FLOOR, ARLINGTON, VA, 22203, US

(73) Assignee: BP P.L.C., LONDON (GB)

(21) Appl. No.: 11/629,880

(22) PCT Filed: Jun. 23, 2004
(86) PCT No.: PCT/GB04/02701

§ 371 Date: Jan. 12, 2007

(51) Int. Cl. B01J 21/08; B01J 21/04

(52) U.S. Cl. 568/957; 423/335; 502/241; 502/242; 502/243; 502/247; 502/250; 502/251; 502/258; 502/260; 502/261; 502/263; 568/956

(57) ABSTRACT

A synthesis of the micro-porous silica gel and its application to preparation of catalysts for C₂ oxygenates synthesis from syngas is invented. The small particles of silica gel which are, produced by sol gel process are heated in a basic solution, followed by drying and/or calcinations, and thus form micro-porous silica as catalyst support. The basic solution can be one or a mixed solution of hydroxides, carbonates, bicarbonates, formates and acetates of alkali metal and ammonium. The obtained micro-porous silica can be impregnated with the solutions of rhodium salt and other transition element salts (as promoter precursors), followed by drying and/or calcinations, thus forming a micro-porous silica supported rhodium based catalyst. The rhodium salt can be RhCl₃ or Rh(NO₃)₃. The promoter precursors can be water-dissolvable transition metal salts, rare earth metals salts, alkali metal salts and alkali earth metal salts. The obtained catalysts show high activity and selectivity in the synthesis of C₂-oxygenates by the hydrogenation of CO under mild process conditions.

This invention involves a preparation method for catalysts using micro-porous silica as a catalyst support In more detail, a micro-porous silica is produced from the particle silica with small pore size produced by the sol technique and used as a catalyst support for rhodium-based catalyst, which is used in the synthesis of C₂-oxygenates by the hydrogenation of CO.

The synthesis of C₂-oxygenates by the hydrogenation of CO has attracted extensive research attention in recent years all over the world. Silica is found to be a good support for the rhodium based catalyst for the synthesis of C₂-oxygenates. These silica particles are usually produced by the sol teclnique. The BET surface area of the silica is in the range of 400 to 900 m²/g and the average pore size is 20 to 99 Å. In order to improve the catalytic performance of the catalysts, we study the influence of the pore structure of the silica on the catalytic performance and explore the convenient synthesis process for micro-porous silica.

The invention is to provide a method to synthesize micro-porous silica as a catalyst support, in which the pore size is enlarged, in order to improve the catalytic properties of the catalysts for the synthesis of C₂-oxygenates.

The technique employed in this invention is to treat the small pore silica which has been produced by the sol technique in aqueous basic solutions or organic solvent such as methanol, and thus the pore size is enlarged. The obtained silica has a BET surface area of 150-350 m²/g, preferably 150-349 m²/g, an average pore size of 100-300 Å, preferably 101-300 Å, and a pore volume of 0.9-1.1 ml/g. The particle size, pore size, BET surface area and pore volume can be tuned by varying types of alkali compounds and their concentrations, treatment temperature and duration. In this way, the obtained silica can be used as a support for rhodium-based catalyst for the synthesis of C₂-oxygenates by the hydrogenation of CO or for other catalytic processes which need micro-porous silica as the catalyst support.
1. The silica particles in this invention can be in any range of particle size, which can be obtained by a widely known sol technique, or commercial products such as those with the particle size in the range of 0.1 to 8 mm produced from Qingdao Marine Chemical Engineering factory and Innermogolia Huhehaote Eerduosi silica factory. An appropriate range of particle size should be chosen according to the required pore size the catalyst support. This invention preferably chooses silica with particle size of 0.1-8 mm.
2. The basic solutions include but are not limited to hydroxides of alkali metals and ammonium hydroxide, for instance, lithium hydroxide, sodium hydroxide, potassium hydroxide and ammonium hydroxide; carbonates, dicarbonates, formates and acetates of alkali metals such as lithium carbonate, sodium carbonate, potassium carbonate solutions. The solvent for these basic solutions is preferably water, but not limited to water. The minimum amount of the solutions for the impregnation is to submerge silica support, which can be 2-10 times of the volume of the silica and preferably 2-5 times. The molar percentage of the alkaline compounds to silica is preferably 1-30 %, more preferably 2-15%. The pH value of the basic solutions is preferably 8-14.
3. The treatment temperature is in the range of 50-200° C., preferably 80-130° C. The treatment temperature depends on the specific alkaline solutions and the silica. There is no special limitation of the treatment duration, which is related to the heat treatment temperature and the concentration of the basic solutions. When the treatment temperature and/or the concentration of the basic solutions are low, the treatment can be prolonged. When the treatment temperature and/or the concentration of the basic solutions are high, the treatment duration can be shortened accordingly. At a high treatment temperature, a high concentration of the alkaline solutions and a prolonged heat treatment in the alkaline solutions, the obtained silica will have a larger pore size and a smaller surface area. The preferable heat-treatment duration in this invention is 1 h to 5 days. The exact treatment duration depends on the types of alkaline solutions, treatment temperature and the precursor silica used.

In this invention, a mechanical stirring or gas flow agitation can preferably be employed during the treatment of silica in alkaline solutions, in order to obtain more homogenous silica particles.
4. Any subsequent treatment of catalyst supports can be applied to the invented silicas in this invention, after the alkaline solution treatment. According to the preferable example, the solution is extracted from the mixture resulting from the alkaline solution treatment, which is followed by washing with a medium such as water. The washed silica is dried or calcined at appropriate temperatures, and thus silica with a larger pore size is obtained as a suitable catalyst support.
5. Rhodium and other additives metal salts are impregnated onto the obtained silica, followed by drying and calcination and other steps which are executed in the conventional impregnation technique. In this way, silica supported rhodium based catalyst is prepared for the synthesis of C₂-oxygenates by the hydrogenation of CO. The rhodium salts can be RhCl₃, Rh(NO₃)₃ and other dissolvable salts. The additives can be dissolvable salts of transition metals (such as Ir, Ru, Co, Fe, Mn, Ti, Zr and V); rare earth metals (such as Ce, Sm and La); alkali metals (such as Li and Na); alkali earth metals (such as Mg and Ba). According to a preferred embodiment of the present invention, the silica supported rhodium based catalyst does not comprise additives like Ag and/or Zr. The catalysts can be prepared by co-impregnation, or stepwise impregnation; drying at room temperature to 150° C. for 1 h to 20 days; calcinations at 150 to 500° C. for 1 to 50 h.

The catalysts for the C₂-oxygenates synthesis from syngas are activated in a H₂ flow at SV=100-5000 h⁻¹, preferably 500-2000 h⁻¹; T=500-750 K, preferably 573-673 K; P=1 atmosphere to 1.0 MPa, preferably 1 atmosphere to 0.5 Mpa (prior to use under synthesis conditions).

The process for the C₂-oxygenates synthesis from syngas using above Rh based catalysts are carried out under following conditions: T=473-723 K, preferably 473-623 K; P=1.0-12.0 MPa, preferably 2.0-8.0 MPa; volume ratio of H2/CO=1.0-3.0, preferably 2.0-2.5; space velocity=1000-50000 h⁻¹; preferably 10000-25000 h⁻¹.

### EXAMPLES

The examples shown below is to explain this invention, but not to restrict the invention.

### Example 1

20 g silica which has been prepared by the sol technique and has a BET surface area of 380 m²/g, average pore size of 98 Å and pore volume of 0.86 ml/g is chosen. The size of the gel particles is in the range of 20-40 mesh. The silica is dipped into a mixture of 90 g water and sodium hydroxide at 90° C. for 12 h, the mol % of the basic salt vs silica being 13,6. The residual sodium hydroxide is washed out by water and drying at 120° C. is performed, forming micro-porous silica. A required amount of RhCl₃, Mn(NO₃)₂, LiNO₃ and Fe(O₃) solution is used to co-impregnate the obtained silica, followed by drying at 120° C. for 6 h. The obtained catalyst has a chemical composition of 1% Rh-1% Mn-0.075% Li-0.05% Fe/SiO2 (by weight).

### Example 2

20 g silica which has been prepared by the sol technique and has a BET surface area of 380 m²/g, average pore size of 98 Å and pore volume of 0.86 ml/g is chosen. The size of the gel particles is in the range of 20-40 mesh. The silica is dipped into a mixture of 90 g water and concentrated ammonium hydroxide at 95° C. for 19 h, the mol % of the basic salt vs silica being 10. The residual ammonium hydroxide is washed out by water and drying is performed at 120° C. for 6 h, forming micro-porous silica.

A required amount of RhCl₃, Mn(NO₃)₂, LiNO₃ and Fe(NO₃)₂ solution is used to co-impregnate the obtained silica, followed by drying at 120° C. for 6 h. The obtained catalyst has a chemical composition of 1% Rh-1% Mn-0.075% Li-0.05% Fe/SiO2 (by weight).

### Example 3

20 g silica which has been prepared by the sol technique and has a BET surface area of 380 m²/g, average pore size of 98 Å and pore volume of 0.86 ml/g is chosen. The size of the gel particles is in the range of 20-40 mesh. The silica is dipped into a mixture of 90 g water and 2 g potassium hydroxide at 95° C. for 21 h. The residual potassium hydroxide is washed out by water and drying is performed at 120° C., forming micro-porous silica. A required amount of RhCl₃, Mn(NO₃)₂, LiNO₃ and Fe(NO₃)₂ solution is used to co-impregnate the obtained silica, followed by drying at 120° C. for 6 h. The obtained catalyst has a chemical composition of 1% Rh-1% Mn-0.075% Li-0.05% Fe/SiO₃ (by weight).

### Example 4

20 g silica which has been prepared by the sol technique and has a BET surface area of 380 m²/g, average pore size of 98 Å and pore volume of 0.86 ml/g is chosen. The size of the gel particles is in the range of 20-40 mesh. The silica is dipped into a mixture of 90 g water and 1.8 g sodium carbonate at 95° C. for 24 h. The residual sodium carbonate is washed out by water and drying is performed at 120° C., forming micro-porous silica. A required amount of RhCl₃, Mn(NO₃)₂, LiNO₃ and Fe(NO₃)₂ solution is used to co-impregnate the obtained silica, followed by drying at 120° C. for 6 h. The obtained catalyst has a chemical composition of 1% Rh-1% Mn-0.075% Li-0.05% Fe/SiO₂ (by weight).

### Example 5

A required amount of RhCl₃.xH₂O, Mn(NO₃)₂, LiNO₃, Fe(NO₃)₂ and H₂IrCl₆ solution is used to co-impregnate the silica obtained in the Example 4, followed by drying at 120° C. for 6 h. The obtained catalyst has a chemical composition of 1% Rh-1% Mn-0.075% Li-0.1 % Fe-0.5% Ir/SiO₂ (by weight).

### Example 6

A required amount of RhCl₃.xH₂O, Mn(NO₃)₂, LiNO₃, Fe(NO₃)₂ and RuCl₃ solution is used to co-impregnate the silica obtained in the Example 4, followed by drying at 120° C. for 6 h. The obtained catalyst has a chemical composition of 1% Rh-1% Mn-0.075% Li-0.1 % Fe-0.5% Ru/SiO₂ (by weight).

The BET surface area, average pore size and pore volume have been obtained by Micromeritics ASAP 2010 and N₂ adsorption-desorption technique.

### Comparison Examples

C7

A required amount of RhCl₃, Mn(NO₃)₂, LiNO₃, Fe(NO₃)₂ solution is used to co-impregnate the original silica used in example 1 (BET surface area of 380 m²/g, average poZre size of 98 Å and pore volume of 0.86 ml/g), followed by drying at 120° C. for 6 h. The obtained catalyst has a chemical composition of 1% Rh-1% Mn-0.075% Li-0.05% Fe/SiO₂ (by weight).

C8

A required amount of RhCl₃, Mn(NO₃)₂, LiNO₃, Fe(NO₃)₂ solution is used to co-impregnate the original silica used in example 1 (BET surface area of 380 m²/g, average pore size of 98 Å and pore volume of 0.86 ml/g), followed by drying at 120° C. for 6 h. The obtained catalyst has a chemical composition of 3% Rh-1% Mn-0.075% Li-0.05% Fe/SiO₂ (by weight).

A series of comparative performance tests were conducted with 0.4 grams (˜0.8ml) samples of the examples catalysts (20-40 mesh). The testing apparatus consisted of a small fixed bed tubular reactor with an external heating system, which was made of 316 L stainless steel with 340 mm length, 4.6 mm inner diameter. The catalyst was in-situ reduced in a flow of H₂ before test. The temperature was raised at 2 K/min from room temperature up to 623 K, and then held at constant for one hour. The H₂ flow rate was 4 l/h at atmosphere pressure. Then the catalyst was shifted into syngas (H2/CO=2) after cooling down to 523 K, and reacted under process conditions of T=593 K, P=3.0 MPa, SV=13000 h⁻¹ for 4 h. The effluent passed through a condenser filled with 150 ml of cold deionised water. The oxygenated compounds from the effluent were captured by complete dissolution into the water in the condenser. The aqueous solution containing oxygenates obtained was analyzed off-line by Varian CP-3800 gas chromatography with an FFAP column, using FID detector and 1-pentanol as an internal standard. The tail gas was analyzed on-line by Varian CP-3800 GC with a Porapak QS column and TCD detector. The properties of the catalysts and their performance (synthesis of C₂-oxygenates by the hydrogenation of CO) are shown in Table 1.

The rhodium catalysts supported on the micro-porous silica obtained in this invention show a higher activity and selectivity in the synthesis of C₂-oxygenates by the hydrogenation of CO. This implies that the invented treatment process for the silica is effective to improve the catalytic properties of the catalysts, which opens a new way to obtain silica-supported catalysts.

TABLE 1
Catalytic performance of the rhodium catalysts supported on different
silica with varying pore structures in the synthesis of C₂-oxygenates
by the hydrogenation of CO*

| | Properties of silica | | | | C₂-oxy |
|---|---|---|---|---|---|
| | | | Pore | C₂-oxy | time-space |
| Examples | Pore size | Surface area | volume | selectivity | yield, |
| No. | nm | m²/g | cm³/g | C % | g/kg · h |
| 1 | 17.2 | 251.9 | 1.082 | 58.2 | 389.1 |
| 2 | 19.3 | 198.4 | 1.065 | 60.7 | 421.9 |
| 3 | 20.5 | 182.7 | 0.89 | 59.9 | 458.4 |
| 4 | 21.0 | 187.1 | 0.98 | 59.7 | 431.4 |
| 5 | 21.0 | 187.1 | 0.98 | 62.3 | 498.2 |
| 6 | 21.0 | 187.1 | 0.98 | 58.4 | 462.5 |
| C7 | 9.8 | 380 | 0.86 | 49.2 | 270.5 |
| C8** | 9.8 | 380 | 0.86 | 40.5 | 340.1 |

*Reaction conditions: H₂/CO = 2 (volume ratio), GHSV = 12000 h⁻¹, 320° C., 3.0 MPa. C₂-oxy = C₂H₅OH + CH₃CHO + CH₃COOH + trace oxygenates of C₃ and C₃⁺
**T = 310° C., the other conditions are the same.

Measurements Methods:
BET specific surface area: ASTM-D3663-99 standard test method for surface area of catalysts and catalyst carriers
Average pore size: ASTM-D4641-94 for calculation of pore size of catalyst from nitrogen desorption isotherms.
Pore volume ASTM-D4222-98 for determination of nitrogen adsorption-desorption isotherms of catalysts by static volumetric measurement.
Particle size distribution: ASTM-D4513-97 for particle size distribution of catalytic materials by sieving.

1. Micro-porous silica having a BET specific surface area of 150 to 350 m²/g, preferably 150 to 349 m²/g preferably 200 to 300 m²/g, an average pore size of 100 to 300 Å, preferably 101 to 300 Å, preferably 150 to 250 Å and a pore volume of 0.5 to 1.5 ml/g, preferably 0.9 to 1.1 ml/g.

2. Method for preparing a micro-porous silica according to claim 1 wherein raw silica is heated in a basic solution, followed by drying and/or calcinations.

3. Method according to claim 2 wherein the raw silica is produced by sol techniques with a small pore size.

4. Method according to claim 2 wherein the basic solution is a basic salt chosen amongst hydroxide, carbonate, dicarbonate, formate or acetate of alkali metal or ammonium or a mixture thereof.

5. Method according to claim 4 wherein the alkali metal is lithium, sodium or potassium.

6. Method according to claim 2 wherein the molar percentage of the basic salt to silica is 1 to 30%, preferably 2 to 15%.

7. Method according to claim 2 wherein the basic solution is an aqueous solution with a pH of 8 to 14.

8. Method according to claim 2 wherein the heating temperature of the basic solution is 50 to 200° C., preferably 80 to 130° C.

9. Method according to claim 2 wherein the heating of the basic solution lasts for 1 hour to 5 days.

10. Method according to claim 2 wherein the raw silica has a particle size of 0.1 to 8 mm.

11. Catalyst for the synthesis of C₂ oxygenates from syngas comprising a micro-porous silica support according to claim 1 and rhodium.

12. Method for preparing a catalyst according to claim 11 wherein the obtained micro-porous silica is impregnated with solutions of rhodium salt and other transition metal salts (as promoter precursors), followed by drying and/or calcinations.

13. Method according to claim 12 wherein the rhodium salt is dissolvable rhodium salts such as rhodium chlorides or rhodium nitrate, or a mixture thereof.

14. Method according to claim 12 wherein the catalyst additive is one or several of dissolvable metal salts such as transition metal salts, rare earth metal salts, alkali metal salts and alkali earth metal salts.

15. Method according to claim 14 wherein the catalyst additive is one or several of dissolvable metal salts such as Ir, Ru, Co, Fe, Mn, Ti, Zr, V, Ce, Sm, La, Li, Na, Mg, Ba.

16. Method according to claim 12 wherein the co-impregnation or stepwise impregnation method is used to prepare the catalyst.

17. Method according to any of claims 12 to 16 wherein the catalysts are dried at room temperature to 150° C., preferably 30 to 130° C., for 1 h to 20 days, and calcined at 150 to 500° C., preferably 200 to 450° C. for 1 to 50 h.

18. Method according to any of claims 12 to 17 wherein the micro-porous silica support is prepared according to claim 2.

19. Catalyst for the synthesis of C₂ oxygenates from syngas obtainable according to claim 12.

20. Use of a catalyst according to any of claims 11 to 19 for the synthesis of C₂ oxygenates from syngas.
